(19) United States
(12) Patent Application Publication
(10) Pub. No.: US 2008/0215571 A1
(43) Pub. Date: Sep. 4, 2008

(54) PRODUCT REVIEW SEARCH

(75) Inventors: Shen Huang, Beijing (CN); Jian-Tao Sun, Beijing (CN); Jianmin Wu, Beijing (CN); Min Wang, Beijing (CN); Zheng Chen, Beijing (CN)

Correspondence Address: LEE & HAYES PLLC, 421 W RIVERSIDE AVENUE SUITE 500, SPOKANE, WA, 99201, US

(73) Assignee: Microsoft Corporation, Redmond, CA (US)

(21) Appl. No.: 12/024,930

(22) Filed: Feb. 1, 2008

Related U.S. Application Data
(60) Provisional application No. 60/892,530, filed on Mar. 1, 2007.

(51) Int. Cl. G06F 17/30

(52) U.S. Cl. 707/5; 707/E17.108

(57) ABSTRACT

This disclosure describes various exemplary methods, computer program products, and user interfaces that provide results for a product review search with opinion snippets and opinion visual graphs. This disclosure describes identifying user opinions by extracting passages that contain subjective opinions from web pages; ranking the user opinions by incorporating sentiment orientations and sentiment topics, where the sentiment orientations are positive or negative; and generating review snippets to indicate user sentiment orientations and to describe user opinions toward product features. This disclosure improves a user product search experience from the following aspects: understanding the product review from snippets instead of browsing the web page; obtaining more information by reading reviews in a shorter time period; and obtaining overall opinions of users of the web through visualized opinion summarization.

### RELATED APPLICATIONS

The present application claims priority to U.S. Patent Application Ser. No. 60/892,530, Attorney Docket Number MS1-3494USP1, entitled, “Product Review Search”, to Huang et al., filed on Mar. 1, 2007, which is incorporated by reference herein for all that it teaches and discloses.

### TECHNICAL FIELD

The subject matter relates generally to product review, and more specifically, to providing results for a product review search with review snippets and a visualization of user opinions.

### BACKGROUND

Many consumers or users of computing devices attempt to locate product reviews through a search engine to locate opinions about products from actual users of these products. The word, opinion is used interchangeably with the words, rating or review from the actual users help consumers or users of computing devices make well-informed purchase decisions and are highly desired.

While product reviews may be available through some search engines, results from product reviews do not reflect a ranking strategy. Instead, the results require additional searching for the desired information. One of the problems with the traditional search engine is that the ranking strategy does not incorporate the inherent characteristics of the product reviews (e.g., sentiment orientation contained in reviews). For example, when a query “Nikon D200 review” is issued, the search results will be ranked based on a relevance to a search query. The relevance is usually measured by overlapping terms between a result page and a query, instead of considering some specific information of reviews, such as the sentiment orientations about products and product features.

Another problem is that the snippets are neither indicative nor descriptive of the actual user opinions towards a product that is considered ‘the target product’. The target product may be described as the product that the user of the computing device is interested in finding reviews for that product. Thus, the snippets are not very helpful for the consumer or user of the computing device to understand the actual reviews or ratings of the target product. For example, the query “Nikon D200 review”, results will show three words, “Nikon”, “D200” and “review”, which are highlighted because they are contained in the search query. The consumers or user of the computing device may have to follow the URL links to check the reviews one by one.

Other problems that commonly occur with product searching, especially in web searching, are that the data size is very large and opinion ranking may not be available. The whole searching experience is not very user friendly for the consumers or users of the computing devices. Additional problems include finding information that is relevant for a given topic instead of being optimized for a review search. These problems indicate there is a need for a product review search method with snippets directed towards the product review and visualization summary.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In view of the above, this disclosure describes various exemplary methods, computer program products, and user interfaces for providing results for a product review search with review snippets and a visualization of user opinions. This disclosure describes identifying user opinions comprising passages that contain subjective opinions from web pages, ranking the user opinions by incorporating sentiment orientations and sentiment topics, generating review snippets to indicate user sentiment orientations, and describing user opinions toward product features for reviews. Also, the disclosure includes presenting a two dimensional polar graph to display variables, such as product features, with different quantitative scales. Thus, this disclosure improves a user product search experience from the following aspects: understanding the product review from snippets instead of browsing the web page; obtaining more information by reading reviews within a limited time; and obtaining overall opinions of users of the web through a visualized opinion summarization. Thus, the product review search offers advantages and convenience to the user of the computing device.

### BRIEF DESCRIPTION OF THE DRAWINGS

The Detailed Description is set forth with reference to the accompanying figures. The teachings are described with reference to the accompanying figures. In the figures, the left-most digit(s) of a reference number identifies the figure in which the reference number first appears. The use of the same reference numbers in different figures indicates similar or identical items.

FIG. 1 is a block diagram of an exemplary system for product review search.

FIG. 2 is an overview flowchart showing an exemplary process for the product review search of FIG. 1.

FIG. 3 is a flow chart showing an exemplary framework for implementing the product review search.

FIG. 4 is a schematic diagram showing an exemplary user interface for the results for one product for the product review search.

FIG. 5 is a schematic diagram showing an exemplary user interface for the results for two products for the product review search.

FIG. 6 is a block diagram showing an exemplary two dimensional polar graph for the product review search.

FIG. 7 is a block diagram of an exemplary two dimensional polar graph for the product review search.

FIG. 8 is a block diagram of an exemplary system for product review search of FIG. 1.

### DETAILED DESCRIPTION

### Overview

This disclosure is directed to various exemplary methods, computer program products, and user interfaces for utilizing a product review search. The process describes identifying user opinions that include passages that contain subjective opinions from web pages, ranking the user opinions by incorporating sentiment orientations and sentiment topics, generating review snippets to indicate user sentiment orientations, and describing user opinions toward product features. The process includes a visual opinion summary for convenience. Also, the disclosure includes extracting product features, extracting opinion appraisals through machine learning techniques by using dictionaries and web resources, and classifying sentiment orientations.

In one aspect, the process includes an affinity rank algorithm to provide opinions regarding diversity and information richness. Thus, the affinity rank algorithm includes metrics of diversity and information richness to measure a quality of search results by using a content based link structure of a group document and a content of a single document in the search results. Thus, this disclosure identifies relevant product features for review which includes a diverse range of opinions.

In another aspect, the disclosure describes a computer-readable storage medium with instructions for receiving a query for a product review search, extracting sentences from a search result page to predicate each sentence into a subjective category, extracting a word or phrase that expresses an opinion from the sentences through machine learning techniques combined with dictionaries and web resources, and classifying sentiment orientations. This disclosure facilitates the user of the computing device in finding results for product review searches with relevant snippets and visual summaries for a general web search.

The described product review search method improves efficiency and provides a convenience during a product review search for the user of the computing device. Furthermore, the product review search method described ranks the product reviews according to the inherent characteristics of the product reviews. Snippets describe user opinions towards the product reviewed and a visual graph presents the user opinions for certain product features. By way of example and not limitation, the product review search method described herein may be applied to many contexts and environments. By way of example and not limitation, the product review search method may be implemented on web search engines, search engines, content websites, content blogs, enterprise networks, databases, and the like.

### Illustrative Environment

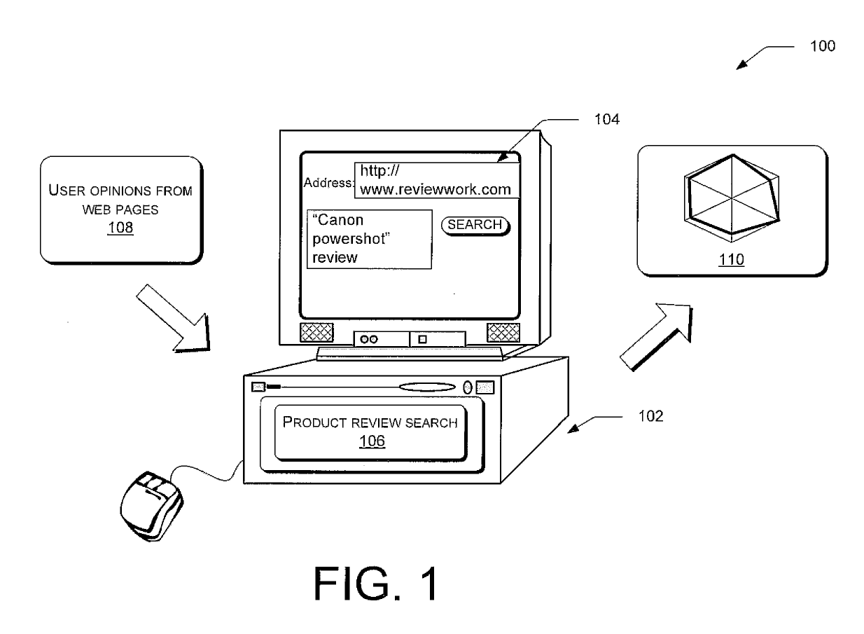

FIG. 1 is an overview block diagram of an exemplary system 100 for providing product reviews for a product review search. Shown is a computing device 102. Computing devices 102 that are suitable for use with the system 100, include, but are not limited to, a personal computer, a laptop computer, a desktop computer, a workstation computer, a personal digital assistance, a cellular phone, and the like. The computing device 102 may include a monitor 104 to display the query information and the product search results. Shown in the monitor 104 is an example of a query for “Canon powershot” review.

The system 100 includes the product review search as, for example, but not limited to, a tool, a method, a solver, a software, an application program, a service, technology resources which include access to the internet, and the like. Here, the product review search is implemented as an application program 106.

Implementation of the product review search application program 106 includes, but is not limited to, identifying user opinions that includes passages that contain subjective opinions from web pages 108. The product review search application program 106 makes use of the subjective sentences from the web pages 108 by extracting a word or a phrase that expresses an opinion from the subjective category as final product features. The product review search application program 106 extracts the product features, extracts opinion appraisals through machine learning techniques using dictionaries and web resources, and classifies sentiment orientations. The product review search application program 106 ranks the user opinions in terms of richness, opinion diversity, topic richness, and topic diversity.

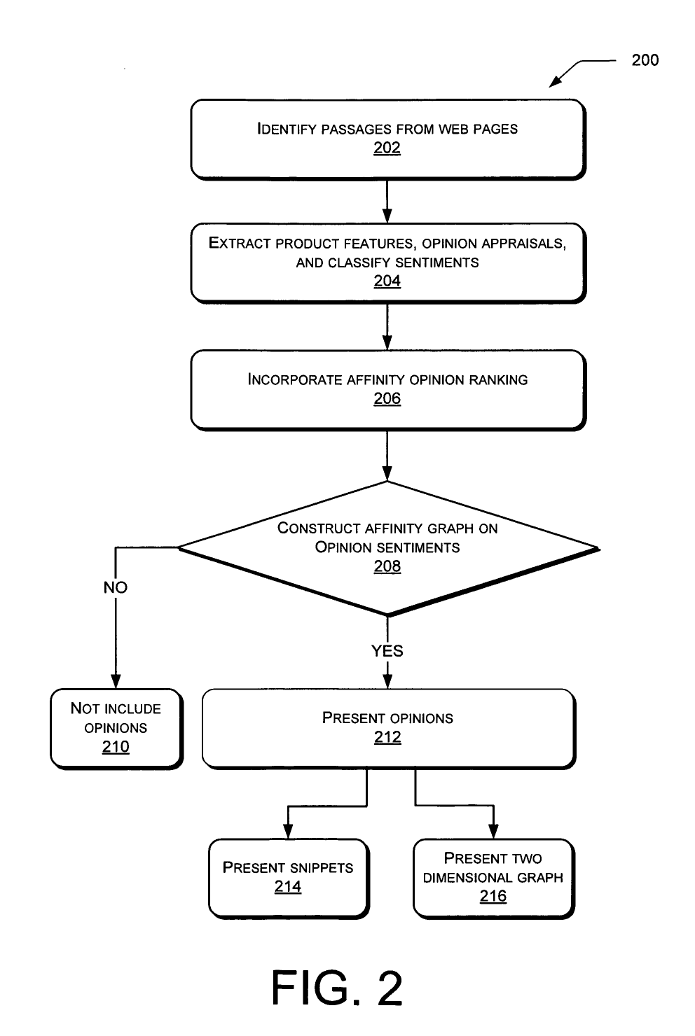

After being processed through the product review search application program 106 (as described above and in more details in FIG. 2), the opinions will be displayed as relevant text phrases and graphs. The opinions are based on a ranking for the product reviews, are shown in a two dimensional polar graph 110, while the snippets are not shown in this figure.

The product review search application program 106 helps generate product reviews that are applicable towards a query directed for a target product. A target product may be described as the product that the user of the computing device is interested in finding reviews for the product. Typically, there were no ranking strategies incorporating inherent characteristics for a product review. Furthermore, there were no snippets shown that were descriptive of user opinions toward the target product. Here, the product review search application program 106 will provide snippets (not shown) and a visual two dimensional graph 110 on the display monitor 104 for convenience in allowing the user of the computing device to glance over the results for the product review search.

### Illustrative Product Review Search

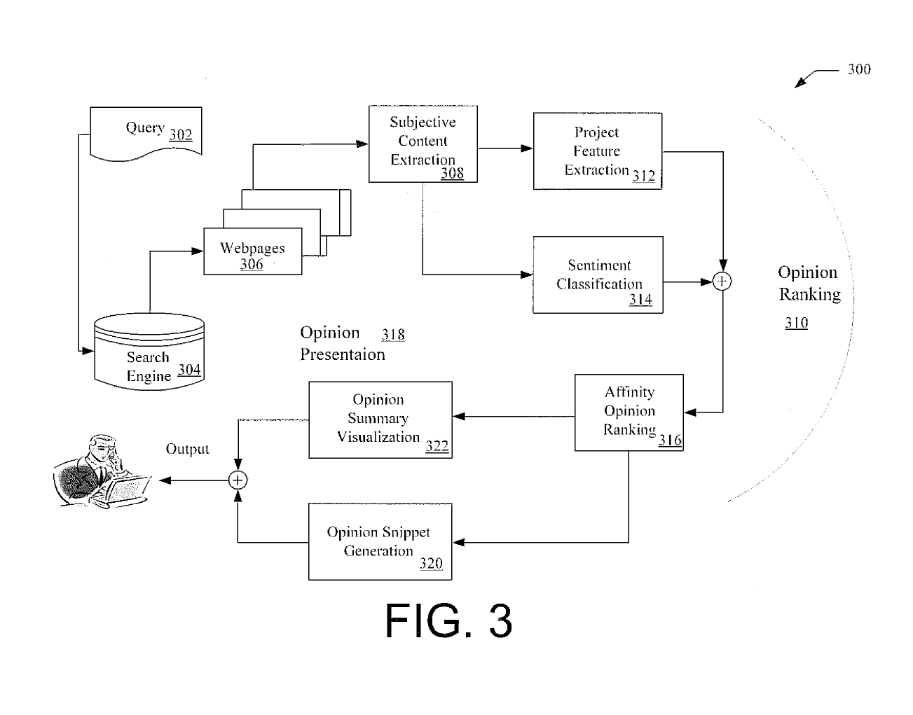

Illustrated in FIG. 2 is an overview exemplary flowchart of a process 200 and in FIG. 3 is an exemplary framework for implementing the product review search application program 106 to provide a benefit to users by ranking user opinions based on product features. For ease of understanding, the method 200 and framework 300 are delineated as separate steps represented as independent blocks in FIGS. 2 and 3. However, these separately delineated steps should not be construed as necessarily order dependent in their performance. The order in which the process is described is not intended to be construed as a limitation, and any number of the described process blocks maybe be combined in any order to implement the method, or an alternate method. Moreover, it is also possible that one or more of the provided steps will be omitted. The flowchart for the process 200 and the framework 300 provides an example of the product review search application program 106 of FIG. 1.

Shown in FIG. 2 at block 202 identifies the passages or sentences with subjective contents by extracting the passages or sentences containing user opinions from web pages returned by a search engine. The passages are then classified into subjective or objective categories. Previous classification attempts suffer from “unseen words” problem, which is quite common due to the far less focused and organized topics discussed on the web. Here, the process 200 uses a Part-Of-Speech (POS) tagging technology to smooth a probability of “unseen words” to improve a subjectivity/objectivity classification accuracy. POS is a technology used to assign tags for words of a natural language sentence. For example, a noun, a verb, an adjective are example of POS.

After the pages with subjective information are identified, the next step is to predict the opinion orientation. The opinion orientation or sentiment analysis classifies people sentiments into positive, negative, or neutral.

Furthermore, importance will be assigned to each opinion. The importance is ranked using two kinds of implicit links constructed to leverage an available link analysis algorithm, such as PageRank, to rank the importance of opinions. One is implicit content link, which connects two opinions if one of them conveys the same content information of the other. The second is the opinion orientation link, which is used to reflect whether the opinions in different reviews will agree or disagree with each other.

Block 204 illustrates extracting product features, extracting opinion appraisals, and classifying sentiments. First, a basic noun phrase will be extracted as a product feature candidate. After compactness pruning and redundancy removal, the frequently appeared ones will be identified as the final product features. Next, extracting opinion appraisals includes using machine learning techniques combined with dictionaries and web resources. Opinion appraisals are a word or a phrase that can express opinions. Adjective words are useful for predicting opinion orientations. However, people express their opinions not only by adjective words but also by adverb, verb, noun and phrase, etc. For example, “badly”, “buy”, “problem”, “give it low score” illustrate use of these types of words.

Block 206 illustrates incorporating affinity opinion ranking. There are two-levels of meaning for opinion quality: one is to get as much as possible comments on different product features, and the second is to get as much as possible opinion polarity on the commented features. Before purchasing a product, the user of the computing device would like to survey a wide range of reviews to avoid a biased opinion. As commonly understood, information coverage is very indispensible.

Affinity Rank is more appropriate for opinion rank for two reasons: the user of the computing device sees opinions from different reviewers and the user of the computing device finds more information by limited reading effort. For the first one, diversity can measure the variety of topics in a group of documents. For the second one, information richness should be taken into consideration.

Two metrics, diversity and information richness, measures the quality of search results by considering the content based link structure of a group documents and the content of a single document in the search results. Thus, Affinity Rank can be used to re-rank the top search results.

Block 208 represents constructing an affinity graph based on opinion sentiments. Two kinds of implicit links maybe constructed to build the affinity graph. One is the implicit content link and the other is the opinion orientation link, that is, the opinions in different reviews may agree or disagree with each other.

From block 208, the process may take a No branch shown on the left side to block 210, if the opinion sentiments are not to be included as part of the affinity graph.

Returning to block 208, if the opinion sentiments are used to construct the affinity graph, the process flow may take a Yes branch to block 212 to present the opinions. The subjective content is ranked following four criteria for ranking product review: opinion richness, opinion diversity, topic richness and topic diversity.

Block 214 presents practical user opinions incorporated into opinion snippets. Opinion based snippets 214 are generated to help users of the computing device to easily understand the main comments on the page instead of browsing the page contents. This allows the end users of the computing device to have a rough idea about the main product comments at a glance.

Block 216 represents the opinions extracted from the result pages summarized by a two dimensional polar graph. The process presents a summary of opinions within all returned pages in a two dimensional polar graph where the axes may represent certain product features that may be of particular interest. Furthermore, one or two products may be presented in the two dimensional polar graph. This will help the user of the computing device quickly get the overall opinions of the product and quickly compare the two products by evaluating the graphs.

FIG. 3 shows an exemplary framework 300 for the product review search application program 106. The framework is shown in three general areas: subjectivity extraction, opinion ranking, and opinion presentation.

The first section, subjectivity extraction is a preprocessing step, to identify the passages or sentences containing the subjective opinion from each result page. FIG. 3 shows a query 302 that is submitted to a search engine 304 to identify passages or sentences from web pages 306 to extract a subjective content 308. A search engine 304 may include but is not limited to, a commercial search engine, a web search engine, and the like. The web pages 306 may include but is not limited to, text, images, videos, multimedia, and the like.

Turning to the second section, opinion ranking 310 may be viewed as product feature extraction 312, opinion appraisal extraction (not shown), sentiment classification 314, and affinity opinion ranking 316. The process 300 includes using the passages or sentences with subjective opinion to extract the product features 312 and determining the sentiment polarity or classification 314 on each feature. Considering both of them, a similarity function is re-defined to construct the affinity graph.

Product feature extraction 312 includes using a basic word or a noun phrase which will be extracted as a product feature candidate. After compactness pruning and redundancy pruning, the frequently appeared word or phrase will be identified as the final product features.

Extracting opinion appraisal includes using machine learning techniques combined with dictionaries and web resources. Opinion appraisal means a word or phrase that can express an opinion. To improve the coverage of the classifier includes modifying the algorithm using the following two methods.

One method is to exploit the user rating information in the reviews collected from shopping sites. Usually, the reviews with five stars are assumed as positive and one star are assumed as negative. Some one star review may also praise some features for a product and vice versa. To remove such noises, a well-trained model is used, which has high precision but low recall, to select sentences with high classification confidence from a large corpus of reviews. After that, the model is re-trained with the expanded training data. With a bootstrapping process, the process can gradually increase the recall of our classifier with little loss of precision.

The other method is that by observing the wrongly classified samples, finding phrases plays an important role in sentiment classification 314. For example, “buy it again”, “get them now” are frequently used phrases in positive comments, while the phrases like “keep away from it”, “avoid this brand” are frequently used phrases in negative comments. To avoid a biased by noisy patterns, a review title is mined because the title is short and often contains such phrases.

The process 300 uses Naïve Bayes to predict the sentiment orientation. Shown below is an implementation of the process for a negative expression. Let oa denotes an opinion appraise, oaᵢ (i=1 . . . n) denotes the appraise in affirmation, oaⱼ (j=1 . . . m) denotes the appraise in negativity (with the negative word being removed), c̅ denotes the opposite class for c, revise Naïve Bayes as follows:

$${c}^{*} ∝ arg {max}_{c ∈ C} \{ P ( c ) \times {\prod }_{i = 1}^{n} P ( {oa}_{i} \vert c ) \times P ( \overline{c} ) \times {\prod }_{j = 1}^{m} P ( {oa}_{j} \vert \overline{c} ) \} .$$

Affinity opinion ranking 316 illustrates incorporating the opinion quality into consideration. There are two-levels of meaning for opinion quality: one is to get as much as possible comments on different product features and the other is to get as much as possible opinion polarity on the commented features. Before purchasing a product, the user of the computing device would like to survey a wide diverse range of reviews to avoid a biased opinion and to help make well-informed purchase decisions.

Affinity opinion ranking 316 is more appropriate for opinion ranking based on two reasons: the user of the computing device may see a diverse range of opinions from different reviewers and the user of the computing device may find more information by reading a small amount of information. For diversity opinions, diversity can measure the variety of topics in a group of documents. For more information, information richness should be taken into consideration. As mentioned, two kinds of implicit links maybe constructed to build an affinity graph. One is the implicit content link, and the other is the opinion orientation link, that is, the opinions in different reviews may agree or disagree each other.

The four components of affinity rank include:
1. Definitions of Information Richness and Diversity: Information richness measures how many different topics a single document contains. Diversity measures the variety of topics in a group of documents.
2. Construction of Affinity Graph: Let D={dᵢ|1≦i≦n} denote a document collection. According to vector space model, each document dᵢ can be represented as a vector \vec{d}ᵢ. Each dimension of the vector is a term and the value for each dimension is the TFIDF of a term. The affinity of dᵢ to dⱼ as

$$aff ( {d}_{i} , {d}_{j} ) = \frac{\vec{{d}_{i}} • \vec{{d}_{j}}}{‖ \vec{{d}_{i}} ‖}$$

3. Link Analysis by Affinity Graph: After obtaining Affinity Graph, the process applies a link analysis algorithm similar to PageRank to compute the information richness for each node in the graph. First, an adjacency matrix M is used to describe AG with each entry corresponding to the weight of a link in the graph. M=(M_{i,j})_{n×n} is defined as below:

$${M}_{i , j} = \{ \begin{matrix}aff ( {d}_{i} , {d}_{j} ) , & if aff ( {d}_{i} , {d}_{j} ) \geq {aff}_{t} \\ 0 , & otherwise .\end{matrix}$$

Without loss of generality, M is normalized to make the sum of each row equal to 1. The normalized adjacency matrix [symbol] M=( [symbol] M_{i,j})_{n×n} is used to compute the information richness score for each node. The richness computation is based on the following intuitions: the more neighbors a document has, the more informative it is; the more informative a document's neighbors are, the more informative it is. Thus, the score of document dᵢ can be deduced from those of all other documents linked to it and it can be formulated in a recursive form as follows:

$$InfoRich ( {d}_{i} ) {\sum }_{all j \neq i} InfoRich ( {d}_{j} ) \cdot {M}_{j , i} .$$

4. Diversity Penalty: Computing information richness helps to choose more informative documents to be presented in top search results. However, in some cases two of the most informative documents could be very similar. To increase the coverage on the top search results, different penalty is imposed to the information richness score of each document in terms of its influences to the topic diversity. The diversity penalty is calculated by a greedy algorithm. At each iteration of the algorithm, penalty is imposed to documents topic by topic, and the Affinity Ranking score gets updated with it. The more a document is similar to the most informative one, the document receives more penalties and the Affinity Ranking score is decreased. Thus, the process 300 ensures only the most informative one in each topic becomes distinctive in the ranking process.

By defining different levels of weights, combining the similarities based on opinion orientation and product features. Two kinds of implicit link are constructed in the same graph. Thus, opinion richness/diversity and topic richness/diversity can be calculated simultaneously. Based on these, re-define the similarity measurement between two documents as follows: Let D={dᵢ|1≦i≦n} denote a document collection and each document dᵢ is represented as a vector \vec{d}ᵢ. The review affinity of dᵢ to dⱼ as:

$$aff ( {d}_{i} , {d}_{j} ) = \frac{\vec{{d}_{i}} • \vec{{d}_{j}}}{‖ \vec{{d}_{i}} ‖} = \frac{{\sum }_{k = 1}^{t} {w}_{k , i} \times {w}_{k , j}}{{\sum }_{k = 1}^{t} {w}_{k , i}^{2}} .$$

Different with a conversional search model, each product feature is treated as one vector dimension and its sentiment as the value. The sentiment value may be obtained by combining the normalized probability of Naïve Bayes classifier with sentiment polarity. If one feature is not neutral, its normalized probability is larger than 0.5. Otherwise, its probability is set as 0.5. Suppose w_{k,i} and w_{k,j} appear in dᵢ and dⱼ respectively. The opinion associated with feature w_{k,i} belongs to class Cₚ and the opinion associated with feature w_{k,j} belongs to class C_{q}, w_{k,i}×w_{k,j} is defined as:

$$\{ \begin{matrix}{w}_{k , i} \times {w}_{k , j} = ( Polarity ( {C}_{p} ) \times Polarity ( {C}_{q} ) ) \times ( P ( {w}_{k , i} \vert {C}_{p} ) \times P ( {w}_{k , j} \vert {C}_{q} ) ) , \\ if Polarity ( {C}_{p} ) \times Polarity ( {C}_{q} ) <> 0 \\ {w}_{k , i} \times {w}_{k , j} = P ( {w}_{k , i} \vert {C}_{p} ) \times P ( {w}_{k , j} \vert {C}_{q} ) .\end{matrix} \\ Polarity ( C ) = \{ \begin{matrix}1 , & if C is Positive Class \\ - 1 , & if C is Negative Class \\ 0 , & if C is Neutral Class\end{matrix}$$

In the InfoRich equation, with a probability 1−c the information will randomly flow into any document in the collection. Here, the process assumes price, product quality and sale service are three important factors in product purchasing. Thus, all the product features are classified into the three general categories. When the user of the computing device want to jump to another review, he or she is more likely to jump to the reviews belonging to the same category. The topic sensitive model is formulated as:

$$\{ \begin{matrix}λ = c {T}^{} λ + ( 1 - c ) v \vec{e} \\ {v}_{j , i} = \{ \begin{matrix}\frac{1}{\vert {T}_{j} \vert} , & i ∈ {T}_{j} \\ 0 , & i ∉ {T}_{j}\end{matrix}\end{matrix}$$

where T={T_{price}, T_{quality}, T_{service}}.

Turning to the third section, opinion presentation 318 includes opinion snippet generation 320 and opinion summary visualization 322. Opinion snippet generation 320 displays the topic keywords in reading the information quickly for the user of the computing device. Here the keywords express opinions, which are also important for a review reader. Assuming that an opinion word or phrase describes the nearest product feature, more weight is assigned to the short segments that contain both product feature (topic keywords) and opinion keywords.

The process defines snippet score as follows:

snippet_score=P(w_{k,i}|C)

where w_{k,i} is a product feature word, P(w_{k,j}|C) is the normalized probability for w_{k,i}. If one feature is not neutral, its normalized probability is larger than 0.5. Otherwise, the probability is set as 0.5.

Next, a greedy algorithm is also adopted to generate opinion snippet 320. The greedy algorithm includes:
1. Set max length (in words) for snippet as n.
2. Select opinion word and product features from the review. Expand each selected word backward and forward up to five words. The short segments are candidate snippets. Calculate a snippet score for each candidate.
3. Let m denotes the length of already selected text. Select the snippet with the highest snippet score from the rest of the candidates.
   a. If the candidate overlaps already selected candidates, merge them.
   b. If the candidate longer than n, truncate it and exit.
4. Let n=n−m, repeat step 3.

After the greedy algorithm is completed, the process 300 highlights the product features, positive appraisals, and negative appraisals with different colors.

Opinion summary visualization 322 provides a two dimensional polar graph where each axis represents a product feature. The graph provides a glimpse on the overall comments without the user of the computing device having to spend a huge amount of effort reading through the product features.

### Exemplary Product Review Search Interface

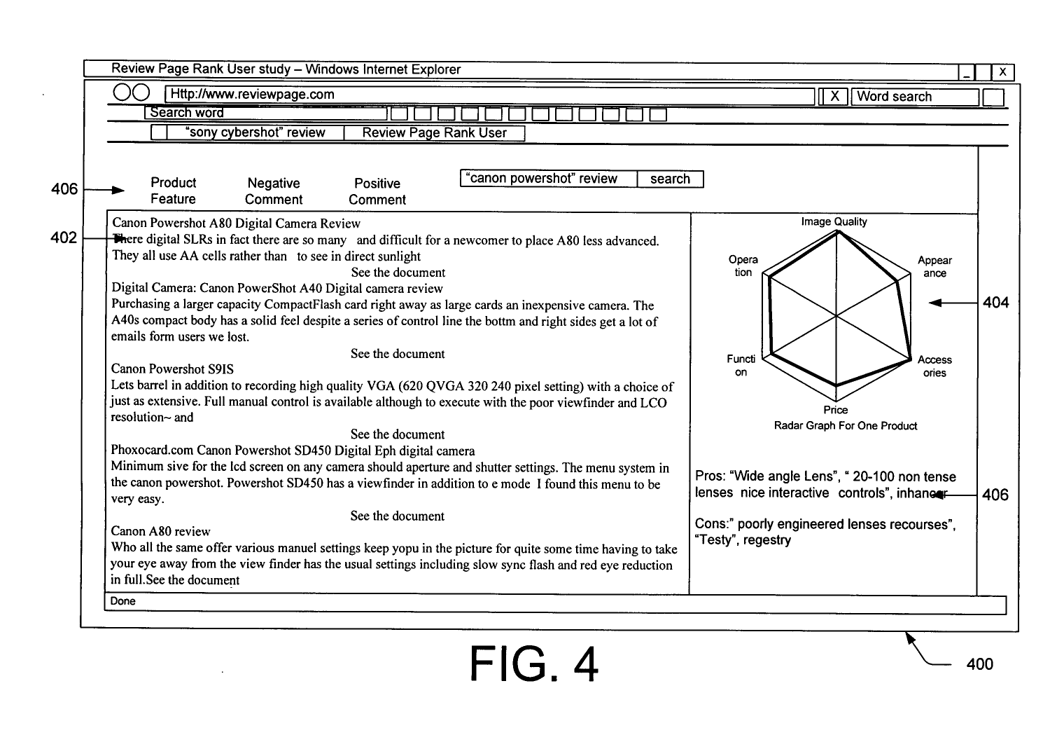

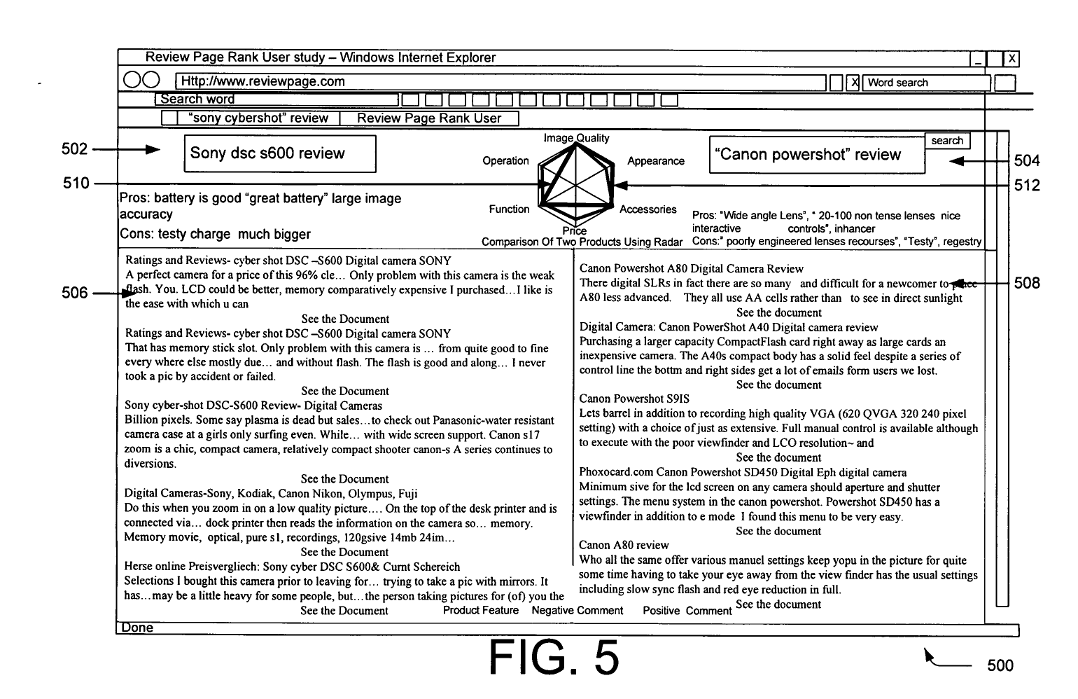

FIGS. 4 and 5 illustrate exemplary product review search interfaces. FIG. 4 illustrates a search results for a single product 400 and FIG. 5 illustrates the search results for a comparison of two products 500.

FIG. 4 shows search results for the single product 400. The interface shows two components presented to the user of the computing device: opinion snippets 402 and visualized opinion summarization 404. For the single product, after a query is submitted, the top 100 results are collected from a search engine and re-ranked by the adapted affinity rank algorithm. Then the process generates opinion based snippets 402 and highlight positive comments, negative comments, and product features 406 for easy understanding. Shown on the right panel, is a radar graph 404 generated by statistics for the top six most frequent product features.

FIG. 5 illustrates a comparison of two products 500, the queries are for product Sony dsc s600 review 502 and for Canon powershot review 504. The snippets containing opinions are listed side by side, shown as 506 for the Sony dsc s600 query and as 508 for the Canon powershot query. Shown are the two radar graphs overlapped to show the differences on different features. Graph 510 represents the opinion reviews for the Sony dsc s600 query, shown as the smaller graph, while graph 512 represents the opinion reviews for the Canon powershot query.

### Exemplary Radar Graphs

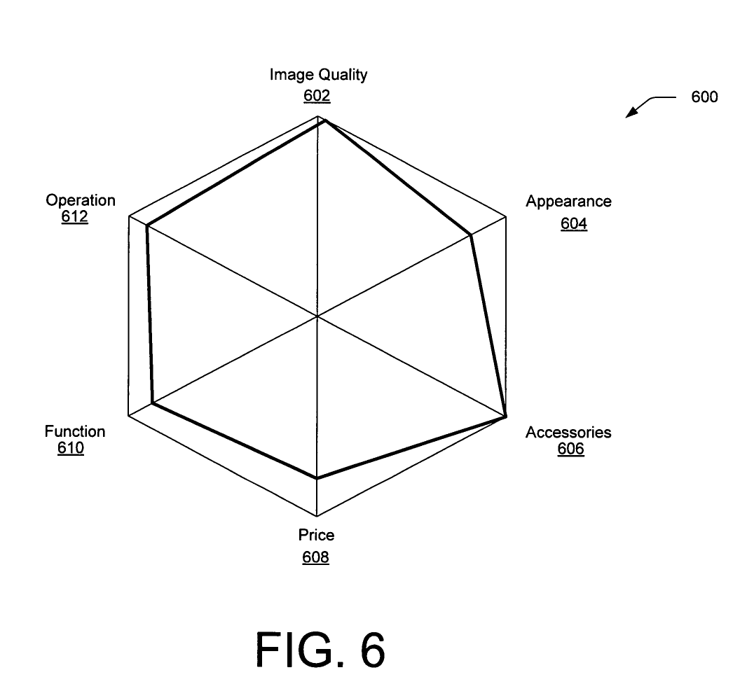

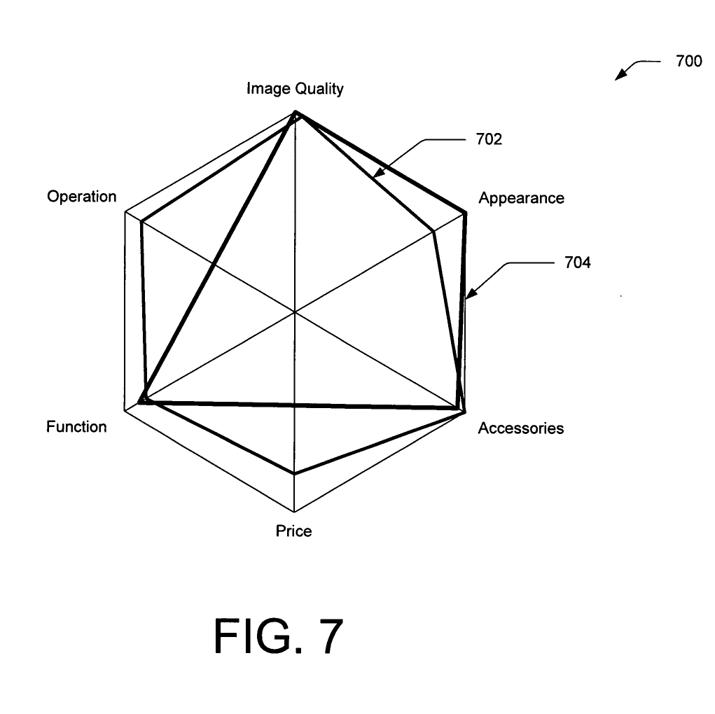

FIGS. 6 and 7 illustrate exemplary radar graphs for the product review search application program 106. FIG. 6 illustrates the radar graph for search results for a single product 600 and FIG. 7 illustrates the radar graph for search results for a comparison of two products 700.

Radar graph, which is also called a spider plot, star or a polar plot, is a two dimensional polar graph that can simultaneously display many variables with different quantitative scales. Radar graph has been studied in data visualization, financial model analysis, mathematical and statistical applications. It is also appeared in RPG Game UI to evaluate avatar multi-features. Here, the radar graph is used for summarizing user sentiments towards products in the product review search application program 106.

FIG. 6 illustrates the radar graph visualizing the opinion summary 600. Each axis at the radar graph stands for a product feature and the length stands for the support ratio of this feature. For example, as shown in FIG. 6, the axes represent different features for digital cameras, i.e. image quality 602, appearance 604, accessories 606, price 608, function 610, and operation 612. The user of the computing device can get an intuitive feeling on the strength and weakness of the product.

FIG. 7 illustrates the radar graph for search results for a comparison of two products 700. When several radar graphs corresponding with different products are put together, the graphs make it easier to show the overall features of a product and to make comparisons among products. For example, 702 shows reviews for one product, Sony dsc s600, while 704 shows reviews for the second product, Canon powershot review. As previously shown in FIG. 6, the axes represent different features for digital cameras, i.e. image quality, appearance, accessories, price, function, and operation. As mentioned, these radar graphs help the user of the computing device get an intuitive feeling on the strength and weakness of the product.

### Product Review Search System

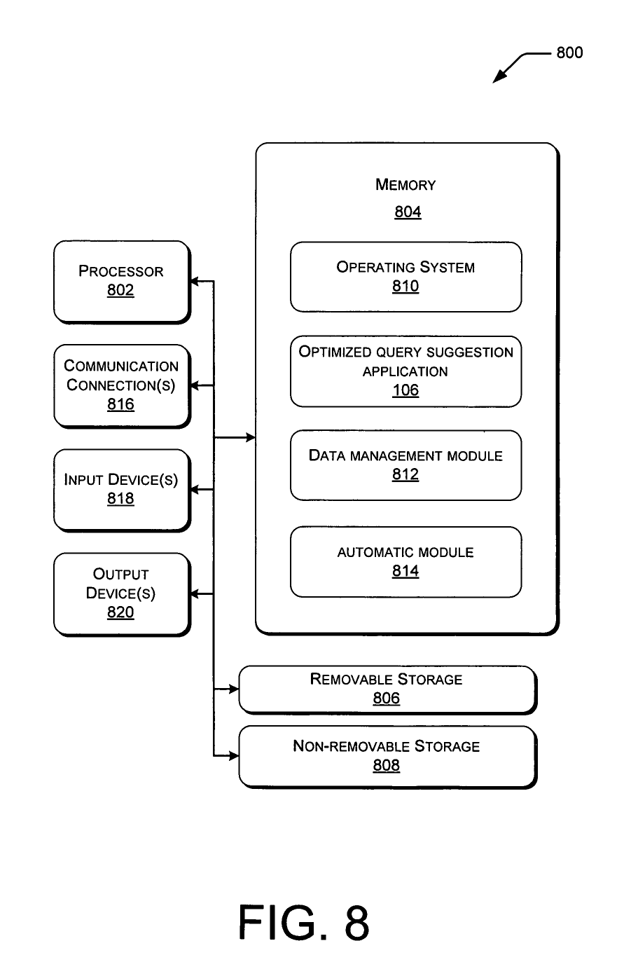

FIG. 8 is a schematic block diagram of an exemplary general operating system 800. The system 800 may be configured as any suitable system capable of implementing the product review search application program 106. In one exemplary configuration, the system comprises at least one processor 802 and memory 804. The processing unit 802 may be implemented as appropriate in hardware, software, firmware, or combinations thereof. Software or firmware implementations of the processing unit 802 may include computer- or machine-executable instructions written in any suitable programming language to perform the various functions described.

Memory 804 may store programs of instructions that are loadable and executable on the processor 802, as well as data generated during the execution of these programs. Depending on the configuration and type of computing device, memory 804 may be volatile (such as RAM) and/or non-volatile (such as ROM, flash memory, etc.). The system may also include additional removable storage 806 and/or non-removable storage 808 including, but not limited to, magnetic storage, optical disks, and/or tape storage. The disk drives and their associated computer-readable medium may provide non-volatile storage of computer readable instructions, data structures, program modules, and other data for the communication devices.

Memory 804, removable storage 806, and non-removable storage 808 are all examples of the computer storage medium. Additional types of computer storage medium that may be present include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by the computing device 102.

Turning to the contents of the memory 804 in more detail, may include an operating system 810, one or more product review search application program 106 for implementing all or a part of the product review search method. For example, the system 800 illustrates architecture of these components residing on one system or one server. Alternatively, these components may reside in multiple other locations, servers, or systems. For instance, all of the components may exist on a client side. Furthermore, two or more of the illustrated components may combine to form a single component at a single location.

In one implementation, the memory 804 includes the product review search application program 106, a data management module 812, and an automatic module 814. The data management module 812 stores and manages storage of information, such as subjective opinions, sentiment orientations, and the like, and may communicate with one or more local and/or remote databases or services. The automatic module 814 allows the process to operate without human intervention. For example, the automatic module 814 in an exemplary implementation, may allow the product review application program 106 to automatically identify the user opinions from segments, to automatically generate review snippets, and the like.

The system 800 may also contain communications connection(s) 816 that allow processor 802 to communicate with servers, the user terminals, and/or other devices on a network. Communications connection(s) 816 is an example of communication medium. Communication medium typically embodies computer readable instructions, data structures, and program modules. By way of example, and not limitation, communication medium includes wired media such as a wired network or direct-wired connection, and wireless media such as acoustic, RF, infrared and other wireless media. The term computer readable medium as used herein includes both storage medium and communication medium.

The system 800 may also include input device(s) 818 such as a keyboard, mouse, pen, voice input device, touch input device, etc., and output device(s) 820, such as a display, speakers, printer, etc. The system 800 may include a database hosted on the processor 802. All these devices are well known in the art and need not be discussed at length here.

The subject matter described above can be implemented in hardware, or software, or in both hardware and software. Although embodiments of click-through log mining for ads have been described in language specific to structural features and/or methodological acts, it is to be understood that the subject matter defined in the appended claims is not necessarily limited to the specific features or acts described above. Rather, the specific features and acts are disclosed as exemplary forms of exemplary implementations of click-through log mining for ads. For example, the methodological acts need not be performed in the order or combinations described herein, and may be performed in any combination of one or more acts.

1. A method for a product review search, implemented at least in part by a computing device, the method comprising:
identifying user opinions by extracting passages that contain subjective opinions from web pages;
ranking the user opinions by incorporating sentiment orientations and sentiment topics; and
generating review snippets to indicate user sentiment orientations and to describe user opinions toward product features.

2. The method of claim 1, wherein sentiment orientations comprise classifying sentiments as positive, negative, or neutral.

3. The method of claim 1, wherein ranking the user opinions comprises extracting product features, extracting opinion appraisals through machine learning techniques using dictionaries and web resources, and classifying sentiment orientations.

4. The method of claim 1, wherein ranking the user opinions comprises an opinion richness, an opinion diversity, a topic richness, and a topic diversity.

5. The method of claim 1, wherein the sentiment orientations are determined using a Naïve Bayesian technique.

6. The method of claim 1, further comprising using an affinity rank algorithm for metrics of diversity and information richness to measure a quality of search results by using a content based link structure of a group document and a content of a single document in search results.

7. The method of claim 1, wherein generating the review snippets comprises assigning a higher weight to a short segment that contains a product feature and opinion keywords.

8. The method of claim 1, wherein generating the review snippets comprises using a greedy algorithm to highlight product features, a positive appraise, and a negative appraise with different colors.

9. A computer-readable storage medium comprising computer-readable instructions executable on a computing device, the computer-readable instructions comprising:
receiving a query for a product review search;
extracting sentences from a search result page to predict each sentence into a subjective category;
extracting a word or a phrase that expresses an opinion from the sentences in the subjective category as final product features;
extracting a word or a phrase that can express an opinion using machine learning techniques combined with dictionaries and web resources; and
classifying sentiment orientations.

10. The computer-readable storage medium of claim 9, further comprising generating review snippets to indicate user sentiment orientations and to describe user opinions toward product features.

11. The computer-readable storage medium of claim 10, wherein generating the review snippets comprises assigning a higher weight to a short segment that contains a product feature and opinion keywords.

12. The computer-readable storage medium of claim 9, further comprising generating a two dimensional polar graph to display variables with different quantitative scales, wherein the polar graph represents an opinion summary.

13. The computer-readable storage medium of claim 9, further comprising using an affinity rank algorithm for metrics of diversity and information richness by measuring a quality of search results by considering a content based link structure of a group document and a content of a single document in the search results.

14. A user interface having computer-readable instructions that, when executed by a computing device, cause the computing device to perform acts comprising:
receiving a query for a product review search;
generating opinion-based snippets by highlighting product features, positive comments, and negative comments;
presenting a two dimensional polar graph to display variables with different quantitative scales, wherein the polar graph represents an opinion summary.

15. The user interface of claim 14, wherein the opinion-based snippets illustrates an understanding of a product review.

16. The user interface of claim 14, wherein the two dimensional polar graph is generated by statistics for a top list of six most frequent product features.

17. The user interface of claim 14, wherein the instructions further cause the computing device to present user snippets containing opinions that are listed side by side to enable comparison of two product reviews.

18. The user interface of claim 14, wherein the instructions further cause the computing device to present a first two dimensional polar graph overlapped with a second dimensional polar graph to illustrate differences for different features for two products.

19. The user interface of claim 14, wherein the instructions further cause the computing device to construct an affinity graph in terms of diversity and information richness, affinity between reviews, and usage of topic sensitive page ranking technologies.

20. The user interface of claim 14, wherein the instructions further cause the computing device to generate opinion-based snippets comprising a greedy algorithm to highlight product features, a positive appraise, and a negative appraise with different colors.
